(19) United States
(12) Patent Application Publication
(10) Pub. No.: US 2016/0009154 A1
(43) Pub. Date: Jan. 14, 2016

(54) SUSPENSION MEMBER

(71) Applicant: Ford Global Technologies, LLC, Dearborn, MI (US)

(72) Inventor: Friedrich Peter Wolf-Monheim, Aachen (DE)

(73) Assignee: FORD GLOBAL TECHNOLOGIES, LLC, Dearborn, MI (US)

(21) Appl. No.: 14/793,994

(22) Filed: Jul. 8, 2015

(30) Foreign Application Priority Data
Jul. 9, 2014 (DE) 102014213273.8

(51) Int. Cl. B60G 3/06; B60G 3/02

(52) U.S. Cl. CPC B60G 3/06; B60G 3/02; B60G 2202/10; B60G 2206/50

(57) ABSTRACT

The invention relates to a suspension member attaching a vehicle wheel to a body or frame of a vehicle. The suspension member includes first and second separate similarly shaped portions. One of the portions having a supporting region that supports a spring element arranged between the suspension member and the vehicle body or frame. The first and second portions having, at least in some section or sections, a contour bent at the edges to form sidewalls. The sidewalls of the respective first and second portions oriented relative to one another so the portions are in contact with one another, at least in some region or regions, via the sidewalls thereof. The first portion having an aperture through which the spring element passes whereby the spring element contacts and is supported by the second portion.

### CROSS-REFERENCE TO RELATED APPLICATIONS

Not Applicable.

### BACKGROUND OF THE INVENTION

1. Field of the Invention

The present invention relates generally to a vehicle suspension attaching a vehicle wheel to the body or frame of a vehicle; and, more specifically, to a suspension member.

2. Description of Related Art

Suspension members or suspension links form part of the wheel suspension system of a vehicle. As part of the running gear, independent wheel suspensions, in particular, are generally constructed from a plurality of members or links in the form of a multi-link axle. In order to allow the inward and outward deflection of the vehicle wheel, the members or links are attached rotatably at least to the body, chassis, frame, or a corresponding sub frame of a vehicle, depending on the vehicle.

Depending on configuration and installation location, a distinction is drawn between longitudinal, diagonal, and transverse suspension members or links. The naming thereof depends on the alignment relative to the direction of travel of the vehicle, a transverse member for example extends substantially transversely to the direction of travel. Attachment to the vehicle is accomplished by means of at least one bearing or bushing, for example, a composite mount in the form of a rubber/metal mount. The rubber component ensures sufficient decoupling and limited mobility of the member relative to the mounting thereof. Attachment to the wheel is accomplished for example by of a ball joint, which allows coupling to a spring strut or to a steering knuckle of the wheel suspension.

Special embodiments of members allow direct combination with a spring element, generally be a coil spring. For this purpose, the body of the member has a suitable receiving region, against which the spring element is supported between the member and the vehicle body, frame, or sub frame. The suspension member can be formed from aluminum or metal sheet. When a metal sheet is used, preferably at least in some region or regions the member is formed to enhance not only individual shape matching but also, in particular, the stability of the suspension member.

Since the moving parts of the wheel suspension are unsprung masses, efforts are being directed toward reducing the weight thereof. This increases driving comfort and, at the same time, reduces vehicle weight, something that is becoming increasingly significant, especially in view of minimizing fuel consumption. Since suspension members are loadbearing components relevant to safety, the design and production thereof has to meet appropriate requirements. Apart from the required capacity for loadbearing, there is also an increasing requirement for predetermined properties in connection with an accident scenario, such as deformation and/or absorption behavior. The advantage of suspension members made from sheet metal over solid suspension members is primarily in the area of weight reduction. On the other hand, the forming steps that are necessary often require an increased outlay for production. This applies especially to the required cross-sectional thicknesses of the semi-finished sheet-metal products used.

Current suspension members also continue to be among the expensive components of a vehicle suspension assembly, primarily to the necessary investment for the required tooling and the corresponding tooling costs. Particularly suspension members produced from very thick materials cause high tool wear in this context. Given the previous embodiments, the production of suspension members therefore continues to leave room for improvement.

### SUMMARY OF THE INVENTION

One embodiment or example of the present invention includes a suspension member for attaching a vehicle wheel to a body or frame of a vehicle, typically a motor vehicle. The suspension member includes first and second separate similarly shaped portions. Each portion having a base and sidewalls, upon placing the portions adjacent one another the respective sidewalls contact each other. The first portion having an aperture through which a spring member or element extends wherein the spring member or element is received and supported by a spring supporting region located on the second portion.

In a further example of the present invention, each of the said first and second portions having an aperture, said apertures aligned with one another. The spring supporting region is located adjacent a circumferential boundary of the aperture in the second portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings.

FIG. 1 is a side view of a suspension member according to the invention in combination with a spring member.

FIG. 2 is a cross-sectional side view of the suspension member according to the invention illustrated in FIG. 1.

FIG. 3 is a plan view of the suspension member according to the invention illustrated in FIG. 1.

FIG. 4 is a plan view of a first portion of the suspension member according to the invention illustrated in FIG. 1.

FIG. 4A is a cross-sectional view of the suspension member illustrated in FIG. 4 taken at line 4A-4A.

FIG. 4B is a cross-sectional view of the suspension member illustrated in FIG. 4 taken at line 4B-4B.

FIG. 4C is a cross-sectional view of the suspension member illustrated in FIG. 4 taken at line 4C-4C.

FIG. 5 is a plan view of a first portion of the suspension member according to the invention illustrated in FIG. 1.

FIG. 5A is a cross-sectional view of the suspension member illustrated in FIG. 5 taken at line 5A-5A.

FIG. 5B is a cross-sectional view of the suspension member illustrated in FIG. 5 taken at line 5B-5B.

FIG. 5C is a cross-sectional view of the suspension member illustrated in FIG. 5 taken at line 5C-5C.

FIG. 6 is a plan view of the suspension member according to the invention in combination with a spring member.

FIG. 6A is a cross-sectional view of the suspension member illustrated in FIG. 6 taken at line 6A-6A.

FIG. 6B is a cross-sectional view of the suspension member illustrated in FIG. 6 taken at line 6B-6B.

FIG. 6C is a cross-sectional view of the suspension member illustrated in FIG. 6 taken at line 6C-6C.

### DETAILED DESCRIPTION OF THE PREFERRED EMBODIMENTS

The following description of the preferred embodiment(s) is merely exemplary in nature and is in no way intended to limit the invention, its application, or uses.

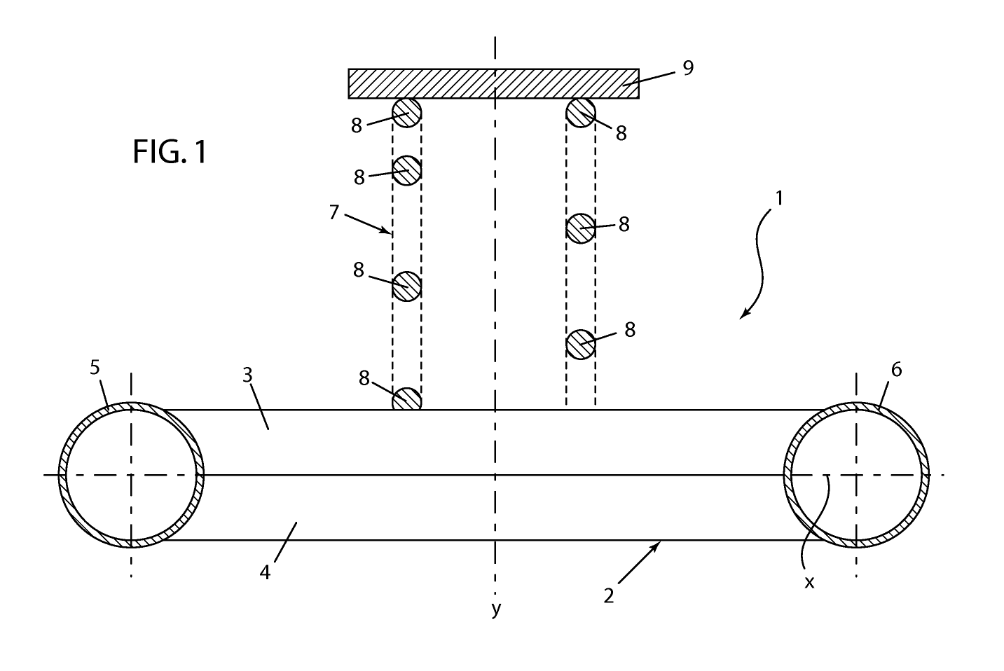

FIG. 1 illustrates a suspension member 1 according to an example of the invention. The suspension member 1 movably supports a vehicle wheel on the body, frame, or sub frame of a vehicle, for example, a motor vehicle. The suspension member 1 includes a body 2 extending in a longitudinal direction x. The body 2 includes first and second portions 3, 4 illustrated in the present example as two U-shaped members or half shells. The first portion or half shell 3 is located on top as illustrated in FIG. 1, while the second portion or half shell 4 is located on the bottom or below the first portion or half shell 3. In the present example, the first and second portions or half shells 3, 4 lie one on top of the other in the plane of the longitudinal axis x.

In the present example, the first and second portions 3, 4 are separately formed parts. Each of the first and second portions 3, 4 being similarly shaped such that each part has the same basic shape. As illustrated, the body 2 is not one piece but is composed of a plurality of parts, including individual first and second portions or half shells 3, 4 wherein the first portion 3 and a second portion 4 are individually formed. In one example, the first and second portions 3, 4 are formed as a semi-finished sheet-metal product using appropriate methods to create the respective portions or half shells. Thus, the individual half shells are pressed from a semi-finished sheet-metal product and simultaneously or subsequently formed into the desired shape.

As illustrated, the first and second portions 3, 4 have the same basic shape including a U-shaped, shell cross-section, each contoured or bent at the edges to form sidewalls 16. In other words, the first and second portions 3, 4 each have regions that are bent or angled at least in some section or sections to form the sidewalls 16. In this manner, the moment of resistance of the first and second portions or half shells 3, 4 in relation to a bending load on the sidewalls 16 is increased. As illustrated, the body 2 formed from the first and second portions or half shells 3, 4 have opposite openings at their respective ends 18. Accordingly, the first and second portions 3, 4 have formed recesses that correspond in their similar basic shape, and which, in the paired state of the first and second portions 3, 4, jointly form the openings. It is, of course, also possible for just one of the first and second portions or half shells 3, 4 to have a formed recess, which then deviates from the basic shape and provides the corresponding openings in combination with the respective other shell half.

Because of its two portion or two-shell configuration, the suspension member 1 according to the invention has a definitely positive effect on the production thereof. Whereby, the same basic or similar shape of the first and second portions or half shells 3, 4 are produced as a mass-produced part with the same tools, and only any differences between the respective first and second portions 3, 4 to be paired with one another are introduced or made in or to the respective basic shape.

The suspension member 1 furthermore comprises two attachment points 5, 6, which are each arranged at the end of the body 2. In this arrangement, they couple the suspension member 1 to a steering knuckle joint (not shown) and to a vehicle structure (not shown). With reference to the illustration in FIG. 1, a first attachment point 5 is located on the left of the body 2, while, in relation thereto, a second attachment point 6 is arranged on the right of the body 2. Accordingly, the suspension member 1 includes a body 2 having at least one attachment point 5, 6. As illustrated, the body 2 preferably has two attachment points 5, 6, which can be either of identical design or of different design. The attachment points 5, 6 are located at an end region of the body 2 and may form the ends thereof. The attachment points 5, 6 couple the suspension member 1 to a steering knuckle joint, vehicle body, or sub frame of a vehicle. As a preferred example, it is contemplated here that the first and second portions or half shells 3, 4 are located adjacent one another with the incorporation of the two attachment points at the respective openings 18 located on each end. The openings 18 provide suitable attachment points either during or after the pairing of the first and second portions or half shells 3, 4. The attachment points may be separate components that serve to attach the vehicle wheel to the vehicle structure via the suspension member 1.

The suspension member 1 according to one example of the invention is combined with a spring element 7, illustrated as coil spring. The individual coils 8 of the spring element 7 are seen in the drawings as circular areas. The spring element 7 extends between the suspension member 1 and a contact region 9 (shown schematically) of the vehicle structure.

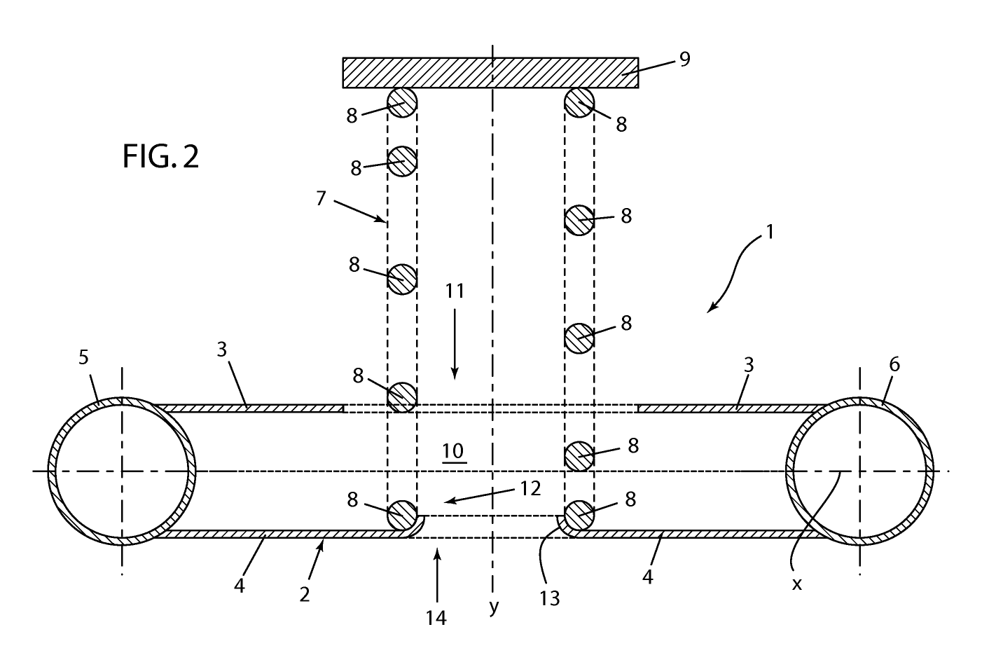

FIG. 2 shows the suspension member 1 according to the invention from FIG. 1 in cross-sectional side view through the body 2. As illustrated, the body 2 has a receiving region 10 for the spring element 7. The receiving region 10 includes a local configuration of the body 2 suitable for enabling a connection between the suspension member 1 and spring element 7, in the installed state. The receiving region 10 is configured in such a way that it serves to receive and support the spring element 7, which is arranged between the body 2 and the vehicle body, vehicle frame, or vehicle sub frame.

As illustrated, the first portion or half shell 3 has an aperture 11 larger than the cross section of the spring element 7. In this way, the aperture 11 forms passage, whereby the spring element 7 passes through the aperture 11 and projects into the intrinsically hollow body 2. In this case, the spring element 7 reaches into the body 2 until it rests on the second portion or half shell 4, forming the bottom of the body 2. Opposite the aperture 11 in the first portion or half shell 3, the receiving region 10 of the second portion or half shell 4 includes a spring element 7 supporting region 12 that supports the end of the spring element 7 located opposite the contact region 9 of the vehicle structure. Various embodiments as regards the receiving region 10 are now conceivable to achieve this. For example, the supporting region 12 may also be fixed as an additional component to the second portion or shell half 4.

As illustrated, the aperture 11 in the first portion or half shell 3 is an opening extending through the first portion or half shell 3. The aperture 11 enables the spring element 7 to pass through the first portion or half shell 3 whereby the second portion or half shell 4 supports the spring element 7. Thus, the aperture 11 ensures that the spring element 7 extends through the first portion or half shell 3 and rests against and is supported by the second portion or half shell 4. The aperture 11 forms a receptacle for the spring element 7 keeping the overall height of the suspension link 1 and spring element 7 combination as small as possible. This is particularly significant, given the assembly of the body 2 from the first and second portions or half shells 3, 4 and the associated cross-sectional height of the body 2 as a hollow body. Since the spring element 7 passes through the first portion or half shell 3, the actual cross-sectional height of the body 2 has no noticeable disadvantageous effect.

In this context, the second portion or half shell 4 includes the supporting region 12 arranged in the region of the aperture 11 in the first portion or half shell 3. According to this, the aperture 11 and the supporting region 12 of the body 2 assembled from the first and second portions or half shells 3, 4 may be aligned congruently, coaxially, or in alignment with one another. In each case, the supporting region 12 of the second portion or half shell 4 is designed to support the spring element 7. Accordingly, actual contact between the spring element 7 and the body 2 advantageously takes place only via just one of the first and second portions or half shells 3, 4, in particular the second portion or half shell 4. This to the extent that the aperture 11 in the first portion or half shell 3 is adequately dimensioned to provide sufficient free space for the spring element 7, which sometimes deflects during compression and rebound.

To secure the location of and center the spring element 7, the supporting region 12 of the second portion or half shell 4 has a raised edge 13, against which the spring element 7 is supported transversely to the longitudinal direction y, at least in some region or regions. In this case, the supporting region 12 includes an aperture or opening 14. The raised edge 13 located adjacent a circumferential boundary of the aperture 14 or encircling the opening 14 in the supporting region 12 of the second portion or half shell 4.

As illustrated, the present example includes the supporting region 12 having a raised edge 13. Further examples include the raised edge 13 being a region(s) oriented differently from the remainder of the second portion or half shell 4 and suitable for providing a kind of fixing for the spring element 7. Thus, the raised edge 13 supports the spring element 7 transversely to the longitudinal direction thereof, at least in some region or regions. In this way, the spring element 7 supported against the second portion or half shell 4 in a manner enabling accurate alignment of the spring element 7 relative to the suspension member 1, even in the case of high amplitudes and short frequencies thereof.

The raised edge 13 supporting region 12 of the second portion or half shell 4 may include a circular flange extending upwards toward the first portion or half shell 3. Further, the raised edge 13 may include a bead located on edge region or circumferential boundary of the aperture 14, such that it forms an encircling collar bounding the aperture 14. The circular flange or encircling collar bounding the aperture 14 secures the position and/or centering of the spring element 7 relative to second portion or half shell 4 of the suspension member 1.

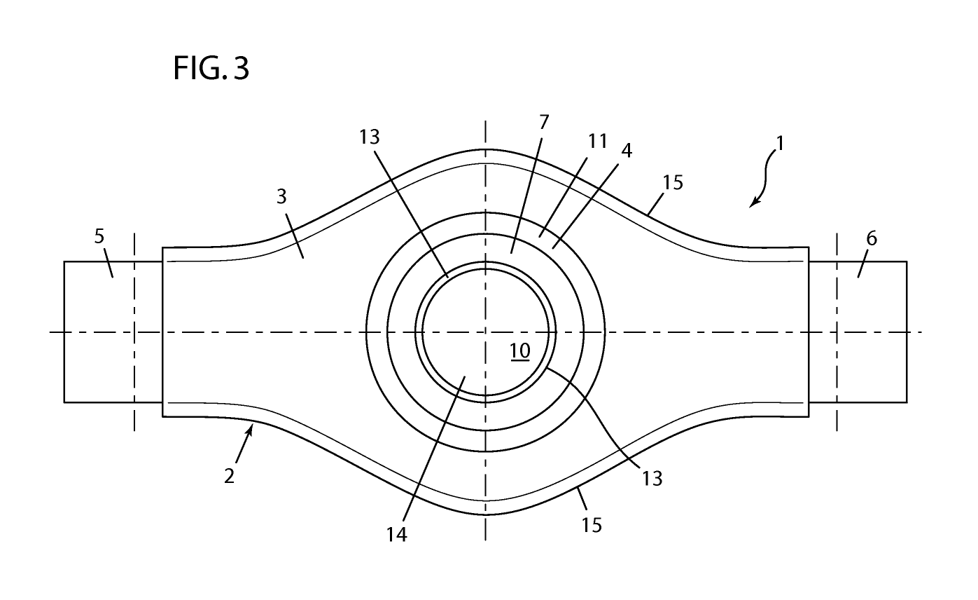

FIG. 3 illustrates the configuration of the suspension member 1 according to the invention in a plan view. As illustrated, the outer contour of the first and second portions or half shells 3, 4 extends around the receiving region 10 for the spring element 7. For this purpose, the region of the first and second portions or half shells 3, 4 between the two attachment points 5, 6 is correspondingly thickened and formed around the receiving region 10, shown having a circular configuration. In contrast, the body 2 tapers toward the two attachment points 5, 6. As shown, the spring element 7 closely surrounds the raised edge 13 of the supporting region 12, while the boundary or edge of the aperture 11 in the first portion or half shell 3 is spaced from the spring element 7.

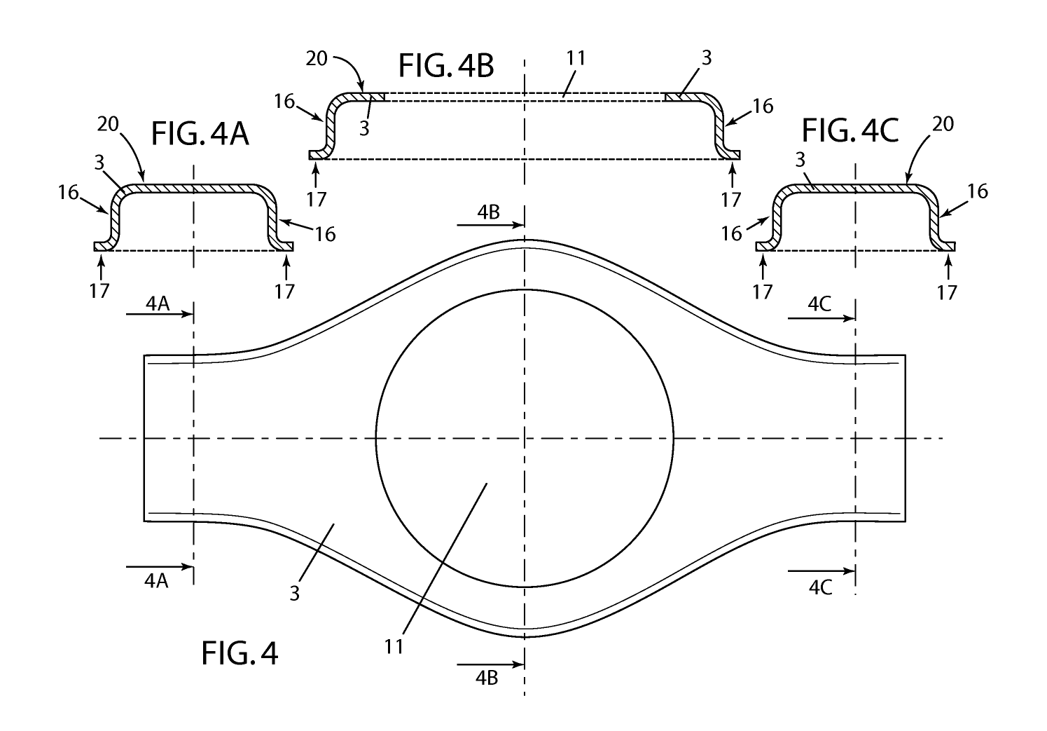

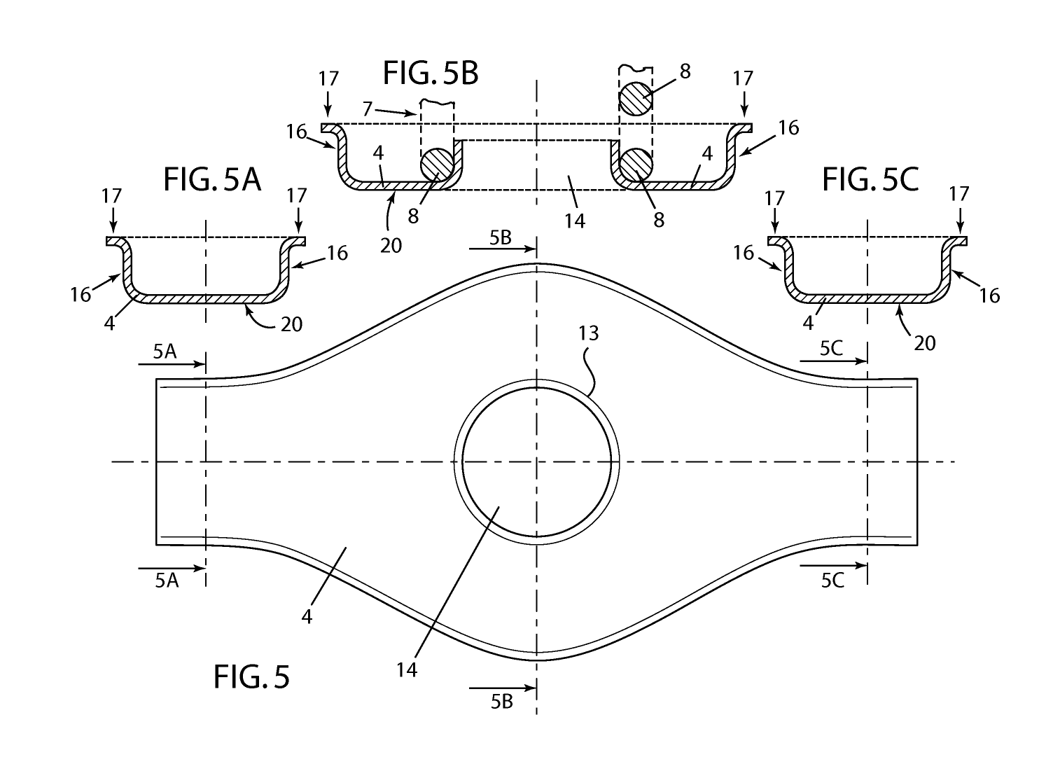

FIG. 4 illustrates the first portion or half shell 3 as a separate component in a plan view. Correspondingly, FIGS. 4A, 4B, and 4C illustrate cross-sectional views taken along respective section lines 4A-4A, 4B-4B, and 4C-4C. FIG. 5 illustrates the second portion or half shell 4 as a separate component in plan view. Similarly, FIGS. 5A, 5B, and 5C illustrate cross-sectional views taken along respective section lines 5A-5A, 5B-5B, and 5C-5C. Referring to FIGS. 4 and 5, and the corresponding cross-sections, both the first and second portions or half shells 3, 4 have a substantially U-shaped cross section including a base 20 and sidewalls 16. As illustrated, the first and second portions or half shells 3, 4 have a contour including a radius of curvature between the base 20 and sidewalls 16. In one example of the invention, the side walls 16 have outwardly extending edge regions or flanges 17 located at the ends thereof. As illustrated, the outwardly extending edge regions or flanges 17 of the respectively opposite side walls 16 are aligned such that they extend or point outwardly away from one another.

Thus, the sidewalls 16 of the first portion or half shell 3 are positioned adjacent to the sidewalls of the respective second portion or half shell 4 in such a way that they contact one another. In another example, the edge regions or flange is 17 of the first portion and second portion 3, 4 contact one another, at least in some region or regions. A combination of the abovementioned possibilities of alignment and contact of the first and second portions or half shells is, of course, also conceivable.

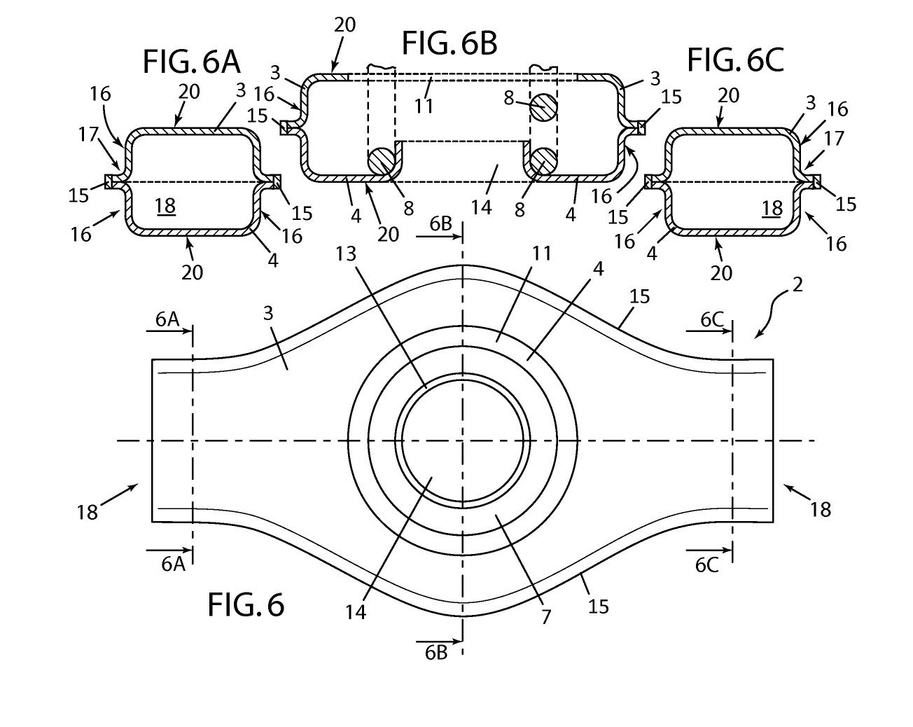

FIG. 6 once again shows the first and second portions or half shells 3, 4 in the state in which they have been assembled to form the body 2, wherein the illustration is similar to FIGS. 4 and 5. It is clear, particularly when viewing the section lines 6A-6A, 6B-6B and 6C-6C, which are likewise shown, that in this example the sidewalls 16 of the first portion or half shell 3 and the sidewalls 16 of the second portion or half shell 4 are oriented with respect to one another in such a way that the first and second portions or half shells 3, 4 contact one another at the side walls 16 in at least in some region or regions. More specifically, in this example the edge regions or flanges 17 of the first portion or half shell 3 and the edge regions or flanges 17 of the second portion or half shell 4 rest on one another at their respective inner surfaces.

In one embodiment or example, the first and second portions or half shells 3, 4 are connected materially to one another by weld seams 15 at the outer contours thereof, which extend between the two attachment points 5, 6. In a further example, the first and second portions or half shells 3, 4 are connected to one another by weld seams 15 at the free ends of the angled edge regions or flanges 17 of the sidewalls 16.

According to an advantageous development, it is contemplated that the respective sidewalls of the first and second portions or half shells 3, 4 can have, at least in some section or sections, edge regions that are angled at the ends. As a result, the sidewalls have an orientation at the free end regions thereof that slopes relative to the way in which they are aligned. As a particularly preferred option, the angled edge regions can be oriented in such a way and/or such that the angled edge regions of the first and second portions or half shells 3, 4 rest upon one another by means of the inner surfaces thereof, at least in some region or regions.

According to an advantageous development of the basic concept of the invention, the first and second portions or half shells 3, 4 are connected to one another at least in some region or regions. By means of a preferably shear-resistant joint for the suspension member, which is in any case embodied as an assembled cross section, the strength values thereof are once again significantly increased by an appropriate joint, as compared with a simple, parallel, unjoined arrangement.

If the angled edge regions are formed on the sidewalls, the first and second portions or half shells 3, 4 can be connected to one another, at least in some section or sections, by means of the free ends of the angled edge regions. Thus, a welded joint, in particular in the form of a spot weld or, preferably, a weld seam, can be arranged at the free ends of the angled edge regions, for example. With reference to the weld seam, this can preferably extend over the entire length of the angled edge regions that rest one upon the other. In this way, not only a strong bond but also a, usually, closed cross section for the link body is achieved, this having advantages in relation to the entry of contaminants and especially of water, which can otherwise result in corrosive attack from the interior of the link body. The joint can be a clamped and/or screwed joint, for example. A suitable plug-in joint is also conceivable here. A particularly advantageous possibility for the joint is a material joint. A material joint is taken to mean an adhesive joint or a welded joint, for example, the latter being preferred especially in connection with the use of first and second portions or half shells 3, 4 made of sheet metal or, more generally, of metal.

As illustrated, both the first and second portions or half shells 3, 4 have the same basic shape. Accordingly, they can be virtually identical in their basic structure, with any differences being formed only afterward. By virtue of the same basic shape, it is now possible to produce them by means of the same tool. The tooling costs, in particular, are minimized significantly since there is no need to make available two tools producing different basic shapes that ultimately jointly form the suspension member.

Of course, the first and second portions or half shells 3, 4 can also be based on the same semi-finished sheet-metal product, wherein the first and second portions or half shells 3, 4 can, for example, be punched out of said product and formed accordingly.

The at least two-part configuration of the suspension member furthermore allows thinner cross sections, wherein the loadbearing capabilities of which are increased to the required extent through the arrangement of the first and second portions or half shells 3, 4 combining to form the suspension member. By virtue of processing the smaller material thicknesses tool wear is reduced. As a result, more economical production of the suspension member is achieved with the suspension member having at least the same strength values as those produced in a conventional way. The first and second portions or half shells 3, 4 are preferably in contact with one another at least in some region or regions via the bent sidewalls thereof.

At the opposite ends of the body 2 in longitudinal direction x, the body 2 has respective openings 18 with first and second portions or half shells 3, 4 of the body 2 connected to one another by the weld seams 15, incorporating the two attachment points 5, 6 (not shown here) within said openings 18.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A suspension member comprising:
first and second separate similarly shaped portions each having a base and sidewalls, said respective sidewalls contacting each other;
said first and second portions each having an aperture, said apertures coaxial; and
a spring supporting region located adjacent a circumferential boundary of said second aperture.

2. The suspension member of claim 1 including a rim located adjacent said circumferential boundary of said second aperture.

3. The suspension member of claim 1 wherein said apertures in said first and second portions are circular; and said aperture of said second portion having a diameter less than a diameter of said aperture of said first portion.

4. The suspension member of claim 2 wherein said rim extends inwardly towards said opposing portion.

5. The suspension member of claim 1 including said first and second portions each having a flange extending transversely to said sidewalls, said flanges forming said contact between said first and second portions.

6. The suspension member of claim 1 including said first and second portions bonded together.

7. The suspension member of claim 1 including a first attachment structure attached to said first and second portions on one end thereof and a second attachment structure attached to said first and second portions on an opposite and thereof.

8. A suspension member comprising:
first and second separate similarly shaped portions each having a base, sidewalls, and flanges extending transversely said sidewalls and contacting each other such that said first and second members form a hollow member having openings at each end;
said first and second portions each having an aperture, said apertures coaxial; and
a spring supporting region including an inwardly extending rim located adjacent a circumferential boundary of said second portion aperture.

9. The suspension member of claim 8 including a first attachment structure attached to said first and second portions on one end thereof and a second attachment structure attached to said first and second portions on an opposite and thereof.

10. A suspension member for attaching a vehicle wheel to a body or to a sub frame of a vehicle comprising a body having two attachment points, the body having a receiving region supporting a spring element arranged between the body and the vehicle body or the sub frame wherein the body has a first half shell and a second half shell, each formed by separate formed parts of the same basic shape, wherein the two half shells each have, at least in some section or sections, a contour bent at the edges to form side walls, and the side walls of the first half shell and the side walls of the second half shell are oriented relative to one another in such a way that the two half shells are in contact with one another at least in some region or regions via the side walls, wherein, to form the receiving region, the first half shell has an aperture through which the spring element passes and the second half shell includes a supporting region arranged in the region of the aperture in the first half shell wherein the supporting region supports the spring element.

11. The suspension member as claimed in claim 10 wherein the two half shells are connected to one another at least in some region or regions, in particular connected to one another materially.

12. The suspension member as claimed in claim 10 wherein the respective sidewalls of the two half shells include, at least in some section or sections, edge regions, wherein the edge regions of the first half shell and the edge regions of the second half shell rest upon one another by means of an inner surface of each of said edge regions, at least in some region or regions.

13. The suspension member as claimed in claim 12 wherein the two half shells are connected to one another, at least in some section or sections, by means of the edge regions of the side walls thereof.

14. The suspension member as claimed in claim 10 wherein the supporting region of the second half shell has a raised edge that supports the spring element transversely to the longitudinal direction thereof, at least in some region or regions.

15. The suspension member as claimed in claim 10 wherein the supporting region of the second half shell half includes a rim hole.

16. The suspension member as claimed in claim 10 wherein the body has opposite openings at each end and wherein the two half shells are connected to one another with the incorporation of first and second attachment points connected the respective openings at each end.
